(19) United States
(12) Patent Application Publication
(10) Pub. No.: US 2020/0370615 A1
(43) Pub. Date: Nov. 26, 2020

(54) Method and System of Corrugated Curved Crease Energy Absorbers

(71) Applicant: Massachusetts Institute of Technology, Cambridge, MA (US)

(72) Inventors: Samuel E. Calisch, Cambridge, MA (US); Neil A. Gershenfeld, Cambridge, MA (US)

(73) Assignee: Massachusetts Institute of Technology, Cambridge, MA (US)

(21) Appl. No.: 16/882,911

(22) Filed: May 26, 2020

Related U.S. Application Data
(60) Provisional application No. 62/852,711, filed on May 24, 2019.

(51) Int. Cl. F16F 7/12; B29D 16/00

(52) U.S. Cl. CPC F16F 7/122; B29D 16/00; F16F 7/124; F16F 2226/042; F16F 2224/02; F16F 2224/0241; F16F 2224/0208

(57) ABSTRACT

A method and system of curved crease foldcores as energy absorbers with rule lines can that lie parallel in the flat state. Corrugated sheet is bonded to the foldcore material such that the corrugations align with the ruling. The curved creases are then cut from the corrugated layer. The image of the corrugation lines under the folding motion remains a line, and the corrugated structure survives and reinforces the folding mechanism. The corrugation significantly increases the second area moment of inertia about the crushing direction, while leaving the second area moment of inertia about the perpendicular direction largely unchanged. Under compressive failure, the corrugated foldcore fails progressively, rather than catastrophically. Also, the corrugations enforce the curved crease pattern, allowing the required curved panels to be bent while disallowing other deformations. This limiting of extraneous deformation aids in manufacturing, and as a global boundary condition readily enforces local folding directions.

This application is related to, and claims priority from, U.S. Provisional Patent Application No. 62/852,711 filed May 24, 2019. It is also related to U.S. patent application Ser. No. 15/934,547 filed Mar. 23, 2018. Applications 62/852,711 and Ser. No. 15/934,547 are hereby incorporated by reference in their entireties.

### BACKGROUND

### Field of the Invention

The present invention relates generally to the field of energy absorbers and more particularly to corrugated, curved crease, energy absorbers.

### Description of the Problem Solved

Energy absorbing structures are used in many contexts to protect sensitive items from impact damage. In particular, energy absorbers (EAs) are used in vehicle bodies to convert the kinetic energy of a crash into mechanical work performed on the material of the EA. To provide adequate protection, the EA must limit the peak force it transmits, while maximizing its capacity for energy absorption. In most applications, both space and mass are limited, so an ideal EA should have high volumetric and gravimetric energy absorption densities. An ideal EA must also behave predictably and favorably subject to geometric imperfections and uncertainty in loading conditions.

Energy absorbers commonly use discrete composite or metal elements like tubes, rings, cones, spheres, etc. Such EAs generally require a custom design for a given application and make poor use of space. Space-filling, sparse structures, such as honeycombs and rigid foams, are more readily applied and make better use of space, but often suffer from high peak forces transmitted and poor gravimetric energy absorption densities. The geometric structure of such EAs are generally limited by manufacturing methods and so are not optimized for performance. Several approaches utilizing 3-D printing have been proposed, but the high cost and poor material properties of such manufacturing is generally prohibitive.

Origami-inspired manufacturing methods have provided significantly expanded and cost-effective capabilities to create geometrically-optimized structures while utilizing high performance materials. Of these, curved crease foldcores have shown great potential, theoretically improving the energy absorption of honeycombs by a factor of two on a volumetric basis [Gattas, 2015]. Experimental work to validate this prediction has been lacking, as fabricating these curved crease foldcores has typically used progressive forming of aluminum sheets. The produced geometries deviate from the ideal shape. Further, the failure modes of these EAs were sensitive to these geometric imperfections, and so the energy absorbing capability did not meet the theoretical predictions. The inclusion of triggering features improved this performance [Gattas, 2014], but not to the level predicted theoretically.

Specifically, if such curved crease foldcores fail catastrophically by buckling, rather than progressively by local material failure, the majority of the material in the EA does not participate in the impact event, and energy absorption is greatly reduced. It would be extremely advantageous to have a method and system of dramatically increasing buckling resistance of curved crease foldcores in a way that is compatible with the manufacturing method. The result would be a manufacturable energy absorber with significantly improved specific energy absorption.

### SUMMARY OF THE INVENTION

The present invention relates to a method and system of corrugated curved crease foldcores as energy absorbers (EAs), where the rule lines can be made to lie parallel in the flat state. Physical instantiation is given to them by bonding a corrugated sheet to the foldcore material such that the corrugations align with the ruling. The curved creases are then cut from the corrugated layer. As the image of the corrugation lines under the folding motion remains a line, the corrugated structure survives and reinforces the folding mechanism. The corrugation significantly increases the second area moment of inertia about the crushing direction, while leaving the second area moment of inertia about the perpendicular direction largely unchanged. The effect is two-fold. First, under compressive failure, the corrugated foldcore is nearly guaranteed to fail progressively, rather than catastrophically. This stabilizes the energy absorption performance subject to uncertainty in geometry and loading. Second, the corrugations enforce the curved crease pattern, allowing the required curved panels to be bent while disallowing other deformations. This limiting of extraneous deformation aids in manufacturing, because a global boundary condition can more readily enforce local folding directions.

### DESCRIPTION OF THE FIGURES

Several figures are now presented to illustrate features of the present invention.

FIG. 1 shows a graphical relationship between the variables R, z, x and the fold angle gamma for curved creases folds from a semi-circular section.

FIG. 2A shows a curved crease foldcore with a ruling drawing.

FIG. 2B shows a foldcore with a ruling-aligned corrugation.

FIGS. 2C-2D show the effect of changing parameters such as gamma, R, wavelength, corrugation pitch and corrugation amplitude.

FIGS. 2E-2F show embodiments of a double-layered corrugation.

FIG. 2G shows a desired cylindrical-shell curved crease 3-D geometry and the computed 2-D geometry.

FIG. 3A shows a corrugated curved crease foldcore realized in B-flute cardboard in the flat state.

FIG. 3B shows the foldcore of FIG. 3A in the folded state.

FIG. 4A shows corrugated curved crease foldcores in aluminum after corrugating.

FIG. 4B shows the foldcores of FIG. 4A after bonding and slitting the creases.

FIG. 4C shows the foldcores of FIG. 4B after folding.

FIG. 5 shows graphically the results of crush tests comparing energy absorption of prior art honeycomb and curved crease foldcores with corrugated foldcores of the present invention.

Illustrations are provided to aid in understanding the present invention. The scope of the present invention is not limited to what is shown in the figures.

### DESCRIPTION OF THE PREFERRED EMBODIMENTS

All developable surfaces in three dimensions, such as those created by folding sheets, are ruled, that is, through every point on the surface there is a line which lies in the surface. In curved crease folding patterns, these rule lines can be considered to define an infinitesimal grid of straight line folds. A curved crease pattern is said to be rigidly foldable if the ruling (collection of rule lines) does not move on the surface during a folding motion. This definition derives from the pattern being the infinite limit of a finite discretization which folds via rigid panels. In other words, no material stretches during the folding motion. These patterns are of interest because they can be realized in stiff physical materials without incurring damage [See for example, Tachi, 2013].

In curved crease foldcores, the rule lines can be made to lie parallel in the flat state. In this case, one can give physical instantiation to them by bonding a corrugated sheet to the foldcore material such that the corrugations align with the ruling. The curved creases are then cut from the corrugated layer. As the image of the corrugation lines under the folding motion remains a line, the corrugated structure survives and reinforces the folding mechanism. Further, the corrugation significantly increases the second area moment of inertia about the crushing direction, while leaving the second area moment of inertia about the perpendicular direction largely unchanged. Under compressive failure, the corrugated foldcore is nearly guaranteed to fail progressively, rather than catastrophically. This stabilizes the energy absorption performance subject to uncertainty in geometry and loading. Also, the corrugations enforce the curved crease pattern, allowing the required curved panels to be bent while disallowing other deformations. This limiting of extraneous deformation aids in manufacturing, as a global boundary condition can more readily enforce local folding directions.

Because corrugation is a scalable process (used at extreme scale in the packaging industry worldwide), such energy absorbers can be cheaply manufactured. Further, such methods can be used on a variety of materials (e.g. aluminum, steel, fiberglass, carbon fiber reinforced polymer, paper, polymer) depending on the application requirements. The size of corrugations can also be considered an additional design degree of freedom (along with others, like curved crease wavelength, amplitude, and shape, leg length and angle, material thickness, and the like). Such corrugated curved crease foldcores can be tailored to fill arbitrary geometries, just as conventional curved crease foldcores. Depending on the application, multiple layers can be stacked to increase thickness without increasing leg length. Corrugations can also be made on one or both sides of a flat liner sheet. Double sided corrugation further increases buckling resistance, but requires a slightly more complicated manufacturing procedure.

To enforce the curved crease folding pattern in the present invention, regions of corrugated layer(s) are cut away. A desired three-dimensional geometry can be programmed by these two-dimensional cuts. In the context of maximizing buckling resistance, cylindrical-shell foldcores are often desirable. To calculate the two-dimensional pattern to produce this, it is advantageous to consider a coordinate system (d, z) normal to the surface ruling. The radius R and the offset x from a semicircular section is used to parameterize the arc sections. An arc length parameter t, measured along the surface, and a fold angle gamma are used to characterize one method of parametrizing the two-dimensional geometry. The fold angle gamma is the angle between one section and the bounding plane.

The coordinate z is related to the offset x and the coordinate d by the following formula:

z=\sqrt{R²−(d+x)²}.

where again R is the radius of the semicircular section.

Differentiating with respect to d:

$$\frac{dz}{dd} = \frac{- ( d + x )}{\sqrt{{R}^{2} - {( d + x )}^{2}}} .$$

If w₀(t) [symbol] is the flat crease curve, one also has with respect to an arc length parameter t:

$$\frac{dz}{dd} = \frac{dz}{dt} \text{/} \frac{dd}{dt} = \frac{\sqrt{1 - {tan}^{2} {γ ( \frac{{dw}_{0}}{dt} )}^{2}}}{tan γ \frac{{dw}_{0}}{dt}}$$

where gamma is the fold angle (again, the angle between one section and the folding plane.

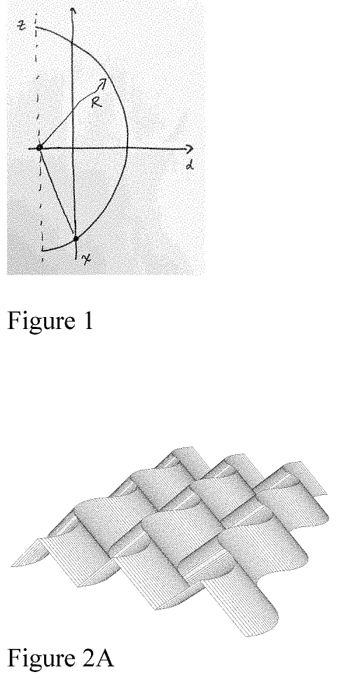

The relationships can be seen in FIG. 1.

Equating the two expressions above and simplifying, one is left with the following nonlinear ordinary differential equation:

$${R}^{2} {tan}^{2} {γ ( \frac{{dw}_{0}}{dt} )}^{2} = {R}^{2} - {w}_{0}^{2} {tan}^{2} γ - 2 x tan γ {w}_{0} - {x}^{2}$$

This equation relates the first derivative of the flat crease curve to the offset x. While, in general, this equation does not have a closed solution, it can be integrated numerically.

In the case of R=1 and x=0, the equation simplifies and admits the simple solution

$${w}_{0} = \frac{1}{tan γ} sin ( t )$$

That is, the crease curve necessary to produce a foldcore with no offset, or in other words semicircular segments at a fold angle gamma, is a sine wave. As stated, in general, the result is not a simple function, but it is not difficult to compute a numerical solution for a given geometry using any one of many numerical integration schemes.

The space curves w₀(t) [symbol] calculated above describe the curved crease to produce a foldcore of cylindrical shell geometry (where t is the space parameter). If the sheet stock has a corrugated layer and a nonzero fold angle gamma, some finite region of corrugate must be removed to avoid collision during folding. The precise region to be removed can be calculated from the equations above and removed from the corrugate. Simpler manufacturing methods, like bevel cutting a constant included angle or removing a constant width strip of corrugate, generally produce results with comparable performance.

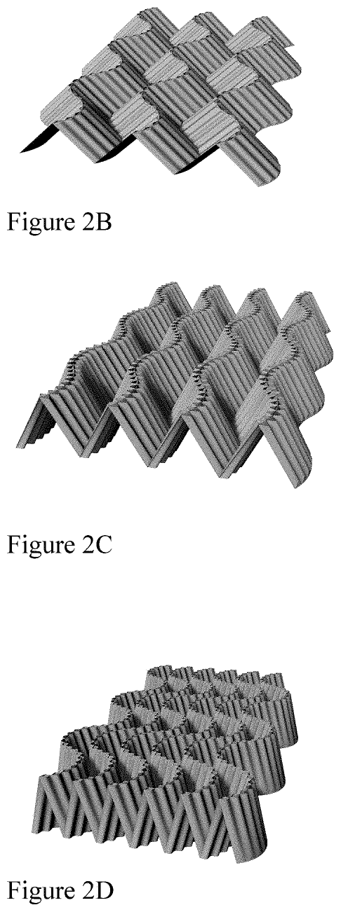

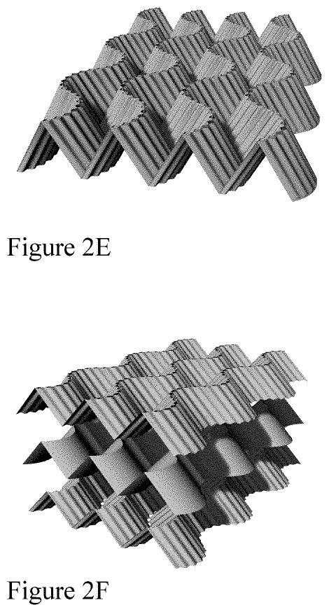

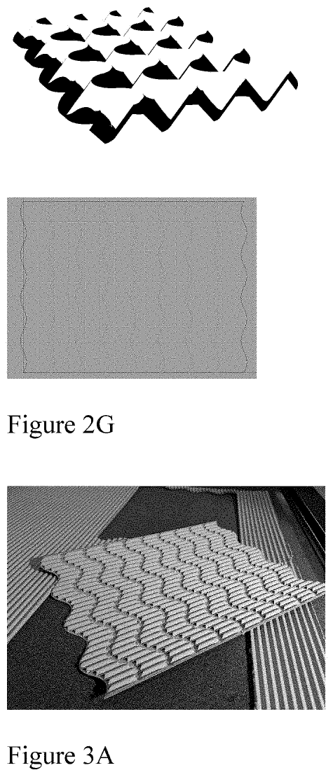

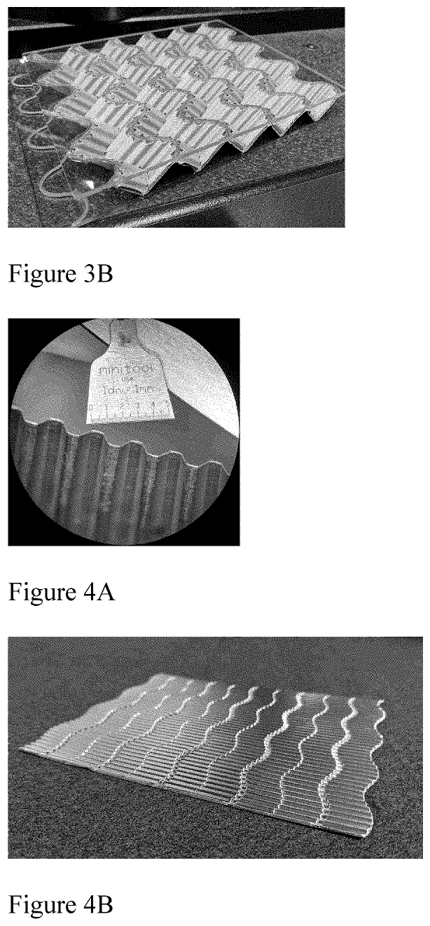

To prove this EA concept, mass-produced corrugated cardboard with one liner sheet was used first. Using a 45 degree bevel cutting CNC knife, the corrugated material at the location of the desired curved creases was carved away. These curved creases were calculated to produce a cylindrical shell in their folded state by solving an ordinary differential equation. The details of this construction can be found in related United States Patent Publication 2018/0272588 (Calisch, 2018). The cut corrugate was then bonded to face sheets to hold it in a folded configuration. This is pictured in FIGS. 2A-2G. FIG. 2A shows a curved crease foldcore with a ruling drawing. FIG. 2B shows a foldcore with a ruling-aligned corrugation. FIGS. 2C and 2D show the effect of changing parameters such as gamma, R, wavelength, corrugation pitch and corrugation amplitude. FIGS. 2E and 2F show embodiments of a double-layered corrugation. FIG. 2G shows a desired cylindrical-shell curved crease 3D geometry and the computed 2-D geometry. FIG. 3A shows a corrugated curved crease foldcore realized in B-flute cardboard in the flat state, while FIG. 3B shows the same foldcore in the folded state.

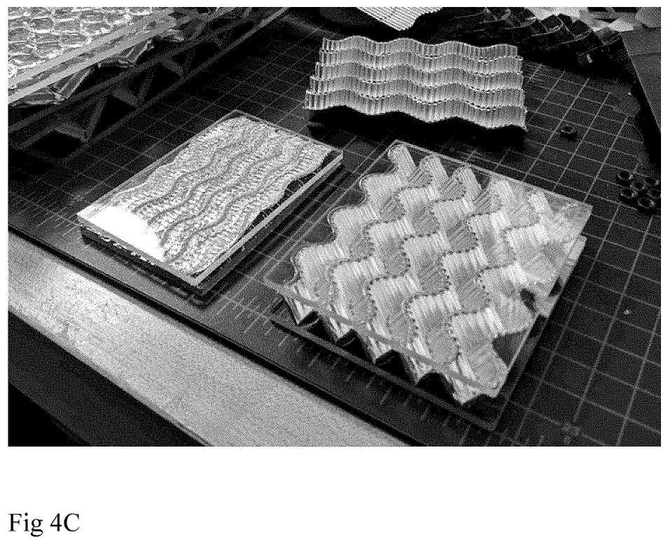

To extend the EA to higher performance materials and geometries, a corrugation machine using standard approaches and corrugated aluminum 1100 series foils with a corrugation pitch of roughly 2 mm was constructed. The foils were 1 and 2 mils in thickness. These corrugated sheets were brought into contact with an adhesive film, coating just the peaks of the corrugation pattern (as is done conventionally when constructing corrugated cardboard), and then bonded to a flat sheet of the same aluminum 1100 series foil. These corrugates were then folded and bonded to face sheets to hold them in their folded states. This is pictured in FIGS. 4A-4C. FIG. 4A shows the corrugated curved crease foldcores in aluminum. FIG. 4B shows the foldcores after bonding and slitting the creases, while FIG. 4C shows the foldcores after folding.

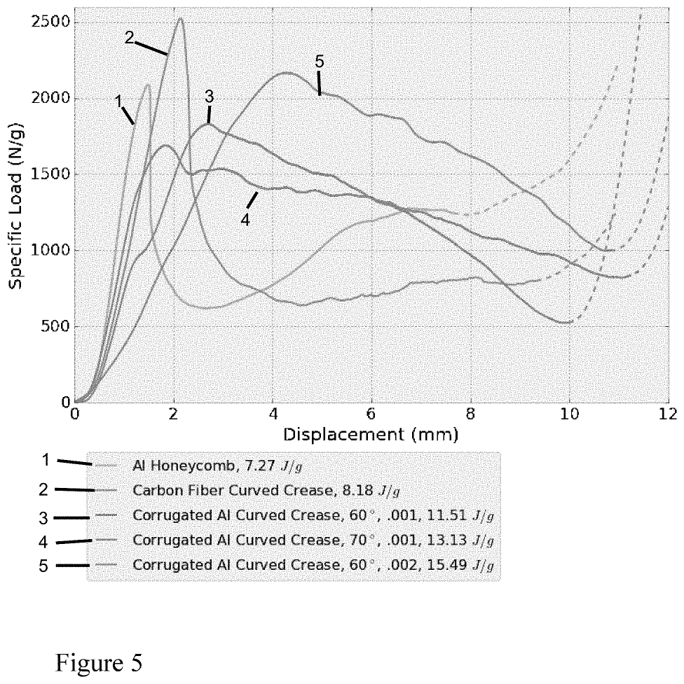

The aluminum corrugated curved crease energy absorbers shown in FIG. 4C were tested on an Instron materials characterization machine to determine their energy absorption capacity. A platen was used to crush the samples at 1 mm/min, and the crushing load was recorded as a function of displacement. These quantities were converted to stress and strain, and the energy absorbed was calculated as the area under this curve until the densification strain. Compared to both aluminum honeycombs and prior art curved crease foldcores, the corrugated samples exhibited much more constant loads (i.e., no high peak). The corrugated samples also exhibited gravimetric specific energy absorption capacities approximately twice that of aluminum honeycombs. A graphical representation of the results of these tests is shown in FIG. 5.

Several descriptions and illustrations have been presented to aid in understanding the present invention. One with skill in the art will realize that numerous changes and variations may be made without deviating from the spirit of the invention. Each of these changes and variations are within the scope of the present invention.

### REFERENCES

1. Composite Rigid-Foldable Curved Origami Structure, Tomohiro Tachi. 2013. https://pdfs.semanticscholar.org/cab7/997c3bd3cb503d2e6b83960eb990b727603b.pdf
2. The behaviour of curved-crease foldcores under low-velocity impact loads, J. M. Gattas and Z. You. 2015. https://www.sciencedirect.com/science/article/pii/S0020768314003989
3. Quasi-static impact of indented foldcores. J. Gattas and Z. You. International Journal of Impact Engineering, 73:15-29, 2014.
4. Curved crease honeycombs with tailorable stiffness and dynamic properties. United States Patent Application 20180272588, Calisch, Samuel E. (Cambridge, Mass., US) and Gershenfeld, Neil A. (Cambridge, Mass., US). 2018.
5. Folded Shell Structures, Mark Schenk. 2011. http://www.markschenk.com/research/files/PhD%20thesis %20-%20Mark %20Schenk.pdf
6. Sandwich panels with cellular cores made of folded composite material: Mechanical behaviour and impact performance. S. Heimbs, J. Cichosz, S. Kilchert, and M. Klaus. In ICCM International Conferences on Composite Materials, 07 2009.
7. S. S. Tolman, S. P. Magleby, and L. L. Howell. Elastic energy absorption of origami-based corrugations. (58189):V05BT08A032-, 2017.
8. H. Z. Zhou and Z. J. Wang. Application of foldcore sandwich structures in helicopter suboor energy absorption structure. IOP Conference Series: Materials Science and Engineering, 248(1):012033, 2017.
9. Y. Li and Z. You. Multi-corrugated indented foldcore sandwich panel for energy absorption. (57137):V05BT08A049-, 2015.
10. R. Fathers, J. Gattas, and Z. You. Quasi-static crushing of eggbox, cube, and modied cube foldcore sandwich structures. International Journal of Mechanical Sciences, 101:421-428, 2015.

1. A method of producing a corrugated curved crease energy absorber comprising:
generating a set of rule lines on a 2-dimensional surface, said rule lines parallel to one-another on said 2-dimensional surface;
bonding a corrugated layer to the 2-dimensional surface so that corrugations align with the rule lines;
making a set of 2-dimensional cuts in the corrugated layer designed to produce a desired 3-dimensional foldcore;
folding the foldcore along the rule lines to produce a 3-dimensional energy absorbing structure.

2. The method of claim 1, wherein a design parameter of the curved crease energy absorber is corrugation size of the corrugated layer.

3. The method of claim 1, wherein the following are design parameters of the curved crease energy absorber: curved crease wavelength, curved crease amplitude, curved crease shape, leg length, fold angle and material thickness.

4. The method of claim 1 further including stacking multiple corrugated layers to increase thickness without increasing length.

5. The method of claim 1, wherein corrugations are made on one side of a flat liner sheet.

6. The method of claim 1, wherein corrugations are made on both sides of a flat liner sheet.

7. The method of claim 1, wherein the foldcore is determined by a differential equation.

8. The method of claim 1, wherein the foldcore is a cylindrical-shell foldcore.

9. The method of claim 8, wherein the cylindrical-shell foldcore is determined by a differential equation.

10. The method of claim 9 wherein the differential equation is
$${R}^{2} {tan}^{2} {γ ( \frac{{dw}_{0}}{dt} )}^{2} = {R}^{2} - {w}_{0}^{2} {tan}^{2} γ - 2 x tan γ {w}_{0} - {x}^{2}$$
wherein, R is a radius of a semi-circular section; w₀ is a space arc parameter w₀(t) of space parameter t; x is an offset from the semi-circular section, and gamma is a fold angle.

11. The method of claim 1 wherein the curved crease energy absorber is aluminum or cardboard.

12. The method of claim 1 wherein the curved crease energy absorber is made from one of aluminum, steel, fiberglass, carbon fiber, reinforced polymer, paper or polymer.

13. A method of producing a corrugated curved crease energy absorber comprising:
generating a curve crease foldcore by solving a differential equation containing parameters of at least a 2-dimensional space curve and a fold angle;
making a set of 2-dimensional cuts in a corrugated layer according to the space curve to produce a cut corrugated layer;
folding the cut corrugated layer to the fold angle along a set of predetermined fold lines to produce a 3-dimensional structure.

14. The method of claim 13 wherein the differential equation includes a radius of a semi-circular section and an offset from that section.

15. The method of claim 14 wherein the differential equation is:
$${R}^{2} {tan}^{2} {γ ( \frac{{dw}_{0}}{dt} )}^{2} = {R}^{2} - {w}_{0}^{2} {tan}^{2} γ - 2 x tan γ {w}_{0} - {x}^{2}$$
wherein, R is a radius of a semi-circular section; w₀ is a space arc parameter w₀(t) of space parameter t; x is an offset from the semi-circular section, and gamma is a fold angle.

16. The method of claim 13 further including stacking multiple corrugated layers to increase thickness without increasing length.

17. A 3-dimensional corrugated curved crease energy absorber comprising at least one layer of corrugated material cut along a set of curved crease curves and folded to a predetermined fold angle about a set of fold lines.

18. The 3-dimensional corrugated curved crease energy absorber of claim 17 wherein the set of curved crease curves are derived from a differential equation.

19. The 3-dimensional corrugated curved crease energy absorber of claim 18 wherein the differential equation relates a space curve to an offset from a semi-circular section.

20. The 3-dimensional corrugated curved crease energy absorber of claim 17 comprising 2 layers of corrugated material.

21. The 3-dimensional corrugated curved crease energy absorber of claim 17 made from one of aluminum, steel, fiberglass, carbon fiber, reinforced polymer, paper or polymer.
